(19) United States
(12) Patent Application Publication
(10) Pub. No.: US 2016/0335238 A1
(43) Pub. Date: Nov. 17, 2016

(54) ANALYTIC DRIVEN MARKUP FOR RAPID HANDLING OF FORMS

(71) Applicant: International Business Machines Corporation, Armonk, NY (US)

(72) Inventors: Varun Bhagwan, San Jose, CA (US); Clemens Drews, San Jose, CA (US); Daniel F. Gruhl, San Jose, CA (US); Neal R. Lewis, San Jose, CA (US); April L. Webster, Mountain View, CA (US); Steven R. Welch, Gilroy, CA (US)

(21) Appl. No.: 14/710,888

(22) Filed: May 13, 2015

(51) Int. Cl. G06F 17/24

(52) U.S. Cl. CPC G06F 17/243

(57) ABSTRACT

Embodiments of the disclosure relate to automatic analytic driven markup for rapid handling of forms. Aspects include receiving a form, identifying one or more characters on the form by performing optical character recognition on the form, and identifying one or more phrases of interest from the one or more characters using automated analytics. Aspects also include generating a map of a spacial location of each of the one or more phrases of interest on the form and creating a revised form based on the form and the map.

### BACKGROUND

The present disclosure relates to automatically marking up paper forms, and more specifically, to methods, systems and computer program products for automatic analytic driven markup for rapid handling of paper forms.

Many businesses receive a large number of paper forms that need to be reviewed and processed. Such forms may be received via facsimile, e-mail, or in person. In general, receiving and processing these paper forms can be a very time consuming processes. Often these forms include a large amount of data that must be identified and entered into a computer system, such as a database. In many cases, the forms may contain a fair amount of information that cannot be dealt with until a few key facts are identified.

### SUMMARY

According to one embodiment, a method for automatic analytic driven markup for rapid handling of forms is provided. The method includes receiving a form, identifying one or more characters on the form by performing optical character recognition on the form, and identifying one or more phrases of interest from the one or more characters using automated analytics. Aspects also include generating a map of a spacial location of each of the one or more phrases of interest on the form and creating a revised form based on the form and the map.

According to another embodiment, a computer program product for automatic analytic driven markup for rapid handling of forms, the computer program product including a tangible storage medium readable by a processing circuit and storing instructions for execution by the processing circuit for performing a method that includes receiving a form, identifying one or more characters on the form by performing optical character recognition on the form, and identifying one or more phrases of interest from the one or more characters using automated analytics. Aspects also include generating a map of a spacial location of each of the one or more phrases of interest on the form and creating a revised form based on the form and the map.

According to another embodiment, a mobile device having a processor configured to perform automatic analytic driven markup for rapid handling of forms is provided. The processor is configured to receive form, identify one or more characters on the form by performing optical character recognition on the form, and identify one or more phrases of interest from the one or more characters using automated analytics. The processor is also configured to generate a map of a spacial location of each of the one or more phrases of interest on the form and create a revised form based on the form and the map.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating one example of a processing system for practice of the teachings herein;

FIG. 2 is a flow diagram of a method for automatic analytic driven markup for rapid handling of forms in accordance with an exemplary embodiment;

FIG. 3 is a flow diagram of another method for automatic analytic driven markup for rapid handling of forms in accordance with an exemplary embodiment; and

FIG. 4 is a flow diagram of a method for performing verification of a form created by the automatic analytic driven markup method in accordance with an exemplary embodiment.

### DETAILED DESCRIPTION

In accordance with exemplary embodiments of the disclosure, method, systems and computer program products for configuring automatic analytic driven markup for rapid handling of forms are provided. In exemplary embodiments, a form is received, for example it may be scanned or faxed, and optical character recognition (OCR) is performed on the form. After the OCR process is completed, analytics are executed on the OCR data to identify one or more phrases of interest in the form. These phrases of interest are highlighted in the scanned image to improve subsequent processing of the forms. In exemplary embodiments, provenance of the OCR data is used to track a spacial location of identified phrases of interest back to the original form, so that the proper area of the form is highlighted. In exemplary embodiments, automatic analytic driven markup of forms allows for significantly faster human processing as the attention of a reviewer can be drawn to the important concepts without having to scan the entire document.

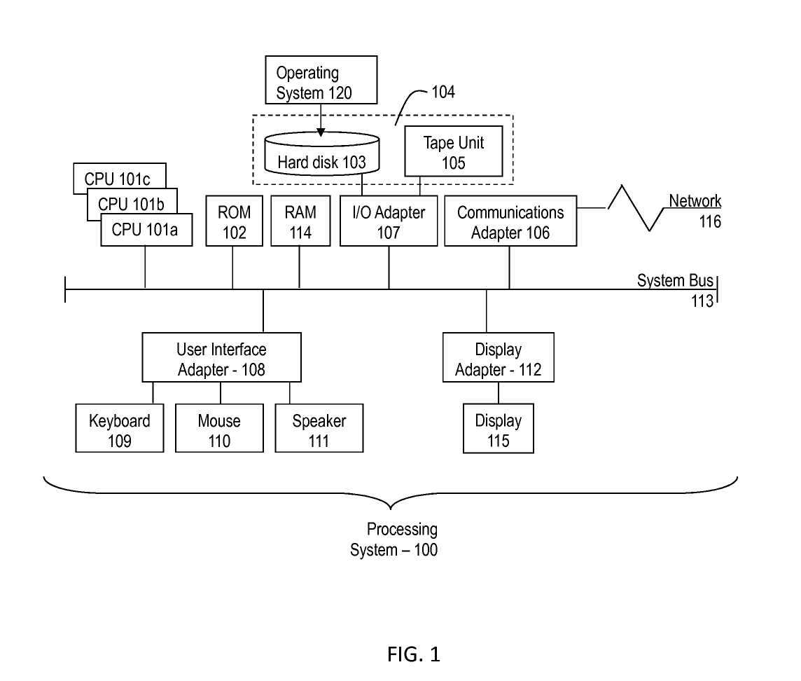

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

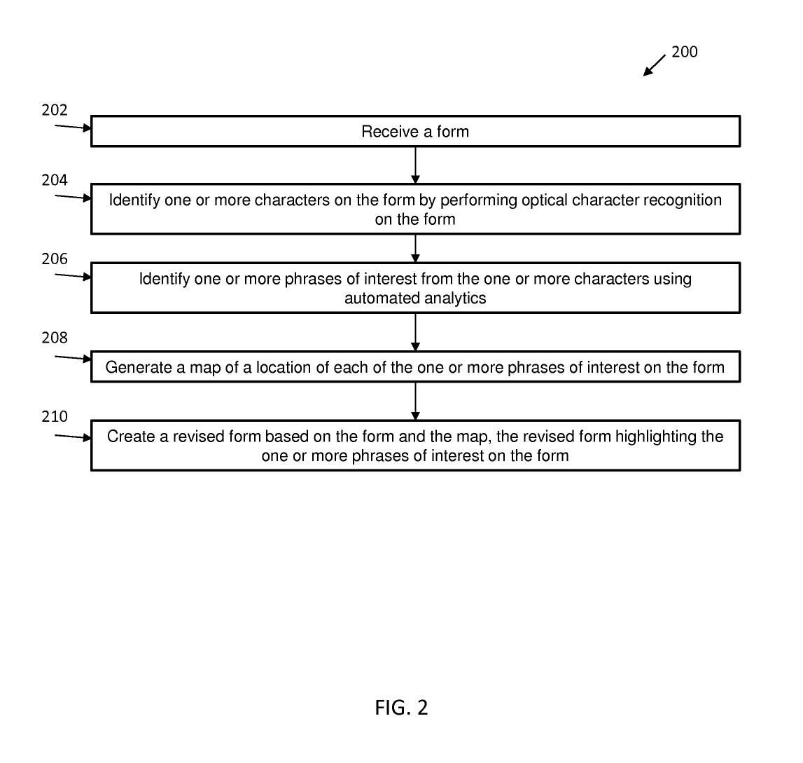

Referring now to FIG. 2, a flow diagram of a method 200 for automatic analytic driven markup for rapid handling of forms in accordance with an exemplary embodiment is shown. As shown at block 202, the method 200 includes receiving a form. In exemplary embodiments, the form is electronically received via a facsimile or a scanner. Next, as shown at block 204, the method 200 includes identifying one or more characters on the form by performing optical character recognition on the form. In exemplary embodiments, any of a wide variety of OCR algorithms may be used. The method 200 also includes identifying one or more phrases of interest from the one or more characters using automated analytics, as shown at block 206. In exemplary embodiments, the automated analytics may include any of a wide variety of known algorithms that can be trained to identify phrases of interest based on the specific use case. Next, as shown at block 208, the method 200 includes generating a map of the spacial location of each of the one or more phrases of interest on the form. In exemplary embodiments, the map can be used to trace the provenance, or the original location, of each of the one or more phrases of interest in the form. In exemplary embodiments, OCR processing of the received forms is configured to keep provenance information to the original image segments of the form for each character identified. Accordingly, as the analytics identify the phrases of interest, the system can utilize the provenance information to track the identified phrases of interest back to their location in the received form.

Continuing with reference to FIG. 2, as shown at block 210, the method 200 includes creating a revised form based on the form and the map, the revised form highlighting the one or more phrases of interest on the form. In exemplary embodiments, such as for online viewing of the image, the highlights in the original document are rendered as active hotspots that upon getting clicked help drive lookups, auto-fill, etc. In the “reprint” case such forms are printed out with the highlights in place to allow rapid scanning and categorizing of the forms.

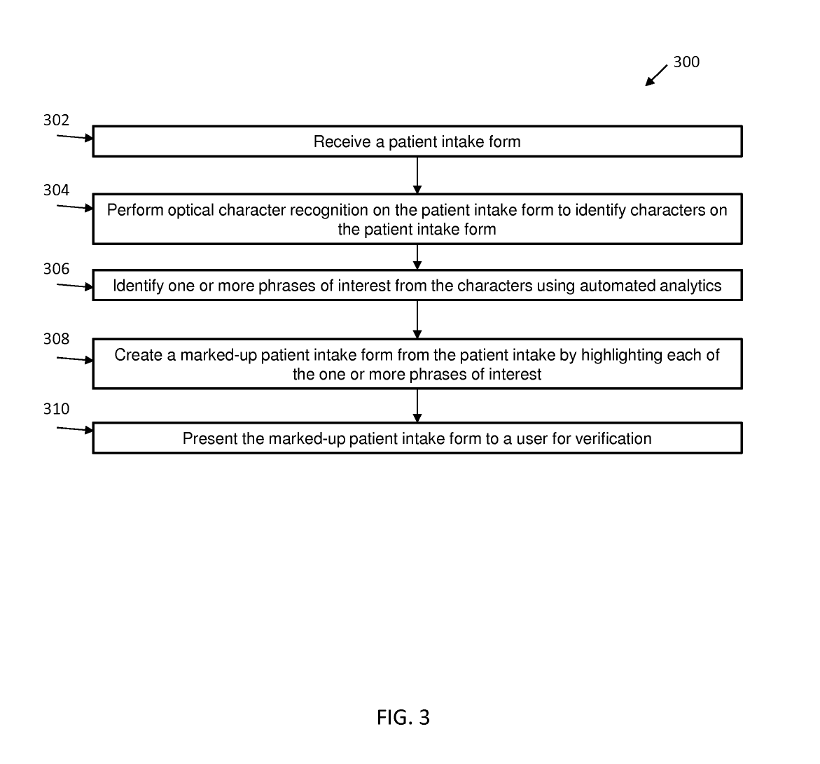

Referring now to FIG. 3, a flow diagram of a method 300 for configuring automatic analytic driven markup for rapid handling of forms in accordance with an exemplary embodiment is shown. As shown at block 302, the method 300 includes receiving a patient intake form. Next, as shown at block 304, the method 300 includes performing optical character recognition on the patient intake form to identify characters on the patient intake form. As shown at block 306, the method 300 also includes identifying one or more phrases of interest from the characters using automated analytics. Next, as shown at block 308, the method 300 includes create a marked-up patient intake form from the patient intake by highlighting each of the one or more phrases of interest. As shown at block 310, the method 300 also includes presenting the marked-up patient intake form to a user for verification. In exemplary embodiments, the highlights in the marked-up patient intake form are rendered as active hotspots that upon getting clicked allow a user to verify the information contained within the phrase of interest. Although example FIG. 3 is a patient intake form, it will be appreciated by those of ordinary skill in the art that the method 300 can be applied to any of a wide variety of form types.

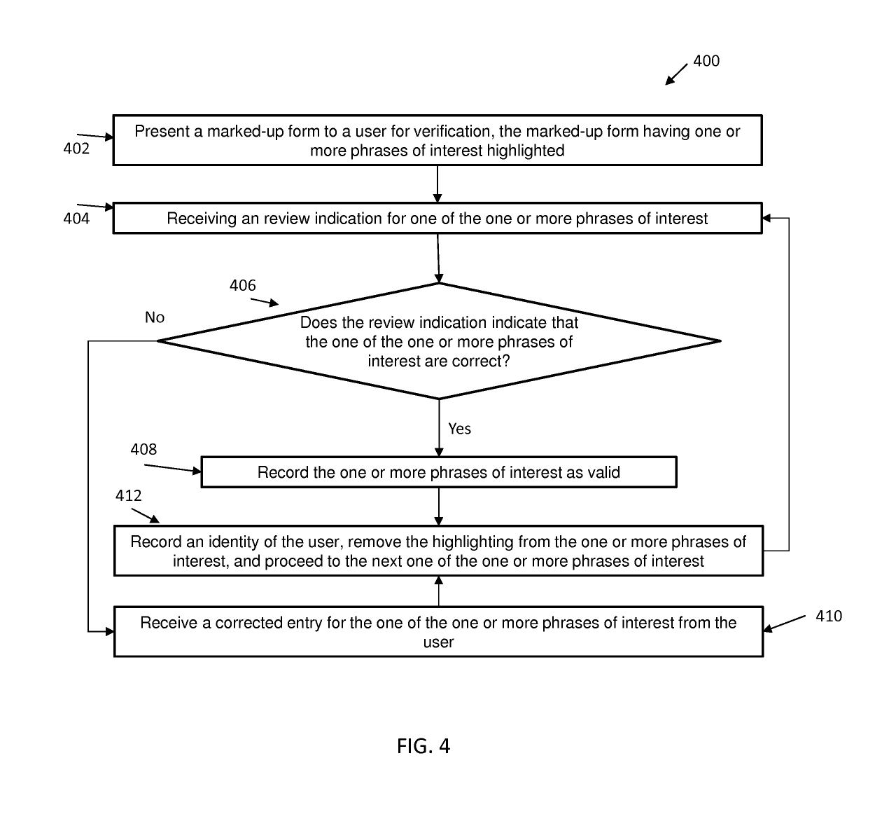

Referring now to FIG. 4, a flow diagram of a method 400 for performing verification of for created by the automatic analytic driven markup method in accordance with an exemplary embodiment is shown. As shown at block 402, the method 400 includes presenting a marked-up form to a user for verification, the marked-up form having one or more phrases of interest highlighted. Next, as shown at block 404, the method 400 includes receiving a review indication for one of the one or more phrases of interest. As shown at decision block 406, the method 400 includes determining if the review indication indicates that the one of the one or more phrases of interest are correct. In exemplary embodiments, the determination that the one of the one or more phrases of interest are correct is made by the user and may include the user simply verifying that the OCR algorithm correctly extracted the text or it may involve a more complex review of the phrase of interest. For example, if the user is a doctor and the form is a patient intake form the determination that the one of the one or more phrases of interest are correct may include the doctor physically verifying the information provided with the patient.

Continuing with reference to FIG. 4, as shown at block 408, the method 400 includes recording that the one or more phrases of interest as valid based on a determination that the one of the one or more phrases of interest is correct. Otherwise, the method 400 proceeds to block 410 and includes receiving a corrected entry for the one of the one or more phrases of interest from the user. Next, as shown at block 412, the method 400 includes recording an identity of the user, remove the highlighting from the one or more phrases of interest, and proceed to the next one of the one or more phrases of interest.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for automatic analytic driven markup for rapid handling of forms comprises:
receiving a form;
identifying, by a processor, one or more characters on the form by performing optical character recognition on the form;
identifying one or more phrases of interest from the one or more characters using automated analytics;
generating a map of a spacial location of each of the one or more phrases of interest on the form; and
creating a revised form based on the form and the map.

2. The method of claim 1, wherein the revised form include a highlighting of the one or more phrases of interest on the form.

3. The method of claim 1, wherein the map is configured to track the spacial location of each of the one or more phrases of interest in the form.

4. The method of claim 1, further comprising presenting the revised form to a user for verification.

5. The method of claim 2, wherein the revised form is an electronic document and the highlighting is rendered as active hotspots.

6. The method of claim 5, wherein upon the active hotspots being clicked the method further comprises receiving an indication from the a user that the one or more phrases of interest are correct

7. A computer program product for automatic analytic driven markup for rapid handling of forms, comprising a computer readable storage medium having program code embodied therewith, the program code is executable by a processor to:
receive a form;
identify one or more characters on the form by performing optical character recognition on the form;
identify one or more phrases of interest from the one or more characters using automated analytics;
generate a map of a spacial location of each of the one or more phrases of interest on the form; and
create a revised form based on the form and the map.

8. The computer program product of claim 7, wherein the revised form include a highlighting of the one or more phrases of interest on the form.

9. The computer program product of claim 7, wherein the map is configured to track the spacial location of each of the one or more phrases of interest in the form.

10. The computer program product of claim 7, wherein the processor is further configured to present the revised form to a user for verification.

11. The computer program product of claim 8, wherein the revised form is an electronic document and the highlighting is rendered as active hotspots.

12. The computer program product of claim 11, wherein upon the active hotspots being clicked the method further comprises receiving an indication from the a user that the one or more phrases of interest are correct

13. A computer system having a processor configured to perform automatic analytic driven markup for rapid handling of forms; wherein the processor is configured to:
receive a form;
identify one or more characters on the form by performing optical character recognition on the form;
identify one or more phrases of interest from the one or more characters using automated analytics;
generate a map of a spacial location of each of the one or more phrases of interest on the form; and
create a revised form based on the form and the map.

14. The computer system of claim 13, wherein the revised form include a highlighting of the one or more phrases of interest on the form.

15. The computer system of claim 13, wherein the map is configured to track the spacial location of each of the one or more phrases of interest in the form.

16. The computer system of claim 13, wherein the processor is further configured to present the revised form to a user for verification.

17. The computer system of claim 14, wherein the revised form is an electronic document and the highlighting is rendered as active hotspots.

18. The computer system of claim 17, wherein upon the active hotspots being clicked the method further comprises receiving an indication from the a user that the one or more phrases of interest are correct.
